(19) United States
(12) Patent Application Publication
(10) Pub. No.: US 2007/0050196 A1
(43) Pub. Date: Mar. 1, 2007

(54) Strategies for providing assets to client devices

(75) Inventors: Shrinath Jadhav, Sunnyvale, CA (US); Lawrence T. Lopez, Cupertino, CA (US); Sukesh H. Pai, Mountain View, CA (US); Rajesh Veeraraghavan, Bangalore (IN)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/215,167

(22) Filed: Aug. 30, 2005

(51) Int. Cl. G06Q 99/00

(52) U.S. Cl. 705/1

(57) ABSTRACT

Functionality is described for providing assets to a client environment, such as a set-top box. The functionality receives a request from the client environment that specifies an original set of parameter name-value pairs. A filtering module filters the original set of parameter name-value pairs to provide a set of germane filtered parameter name-value pairs. A matching module identifies a set of candidate assets which have characteristics which either exactly or partially match the parameter name-value pairs of the filtered set. A matching module resolves partial matches by applying preference analysis. The functionality is advantageous because it provides an intelligent mechanism for supplying assets which match asset requests, without requiring an exhaustive a priori one-to-one mapping between assets and the set-top boxes that can utilize the assets. The functionality also provides a highly extensible design.

### BACKGROUND

A media delivery system provides media information (such as television programs, movies, music, and so forth) for presentation at a plurality of client devices. Some media delivery systems can interact with different models of client devices, with each model having different capabilities. Further, even the same model of a client device can be governed by different programming logic. For example, consider the case in which a media provider delivers television programs and movies via a cable and/or satellite infrastructure to a plurality of set-top boxes located in the respective homes of viewers. These set-top boxes may have different hardware capabilities. Further, the set-top boxes can execute different application programs. Indeed, considering that the set-top boxes can vary in a number of different respects, the possible permutations of different kinds of set-top boxes can easily expand into a relatively large group.

Due to the above-described variety in set-top boxes, it becomes a potentially challenging task to provide resources (i.e., “assets”) to these different set-top boxes. This is because different set-top boxes may have different requirements, and an asset that may be appropriate for one kind of set-top box may not be appropriate for another set-top box. The task of matching an appropriate asset to a given set-top box can be particularly difficult in view of the above-described large number of possible permutations of set-top box types. More specifically, it can become a difficult accounting task to ensure that proper assets go to appropriate set-top boxes.

Accordingly, there is an exemplary need for effective techniques for providing assets to set-top boxes.

### SUMMARY

Strategies are described herein for providing assets to a client device, such as a set-top box. In this approach, the set-top box sends a request for one or more assets to an asset delivery system. The request specifies the asset (or assets) being sought and also includes an original set of parameter name-value pairs that describe the characteristics of the set-top box, such as its hardware capabilities, regional affiliation, language used to present information (e.g., English, Spanish, etc.), level of service (e.g., gold, silver, basic, etc.), and so on. That is, a parameter name identifies the subject matter (e.g., the “type”) of parameter (such as language), and a parameter value identifies a specific species of the subject matter (such as English). At the asset delivery system, a filtering module receives the original set of parameter name-value pairs and selects only those parameter types that are relevant to the request. For example, for a request for electronic program guide (EPG) information, the filtering module may extract parameter name-value pairs in the original set of parameter name-value pairs pertaining to regional affiliation, language, and so forth, but discard other parameter name-value pairs. The filtering module produces a filtered set of parameter name-value pairs.

Next, the filtering module sends the filtered set of parameter name-value pairs to a matching module. The matching module interrogates a database of assets to determine all candidate assets which match the parameter name-value pairs specified in the filtered set of parameter name-value pairs. More specifically, a set of candidate assets will include any asset which has characteristics which satisfy all of the parameter name-value pairs in the filtered set of parameter name-value pairs. The set of candidate assets will also include candidates which only partially match the filtered set of parameter name-value pairs, meaning that these assets match some but not all of the parameter name-value pairs in the filtered set of parameter name-value pairs. On the other hand, the set of candidate assets will exclude any asset which has at least one characteristic that is not specified in the filtered set of parameter name-value pairs.

The set of candidate assets may include two or more assets of a specified type, such as two or more assets pertaining to a certain kind of game, each of which partially matches the filtered set of parameter name-value pairs. In one implementation, the matching module only returns one asset of a certain type. To achieve this result, the matching module can apply preference analysis to determine which candidate asset to return to the set-top box. In one case, the preference analysis comprises using a predetermined ranking of parameter types to select a preferred candidate asset. For example, if one candidate asset matches parameter name-value pair A=a₁ and another candidate asset matches parameter name-value pair B=b₂, and if parameter type B is ranked higher than parameter type A, then the matching module will select the candidate asset that matches parameter name-value pair B=b₂. In more advanced cases, the preference analysis can assign weights to the parameter types, and can then compute a score for each candidate asset that is based on some function of the weights assigned to the candidate's matching parameter types. The preference analysis can then select the candidate asset having the best score (e.g., the highest score).

In one implementation, the head-end infrastructure employs different asset systems to handle different kinds of assets. For example, one kind of asset system may address the selection of assets pertaining to games, another kind of asset system may address the selection of assets pertaining to guide information, another kind of asset system can address the selection of assets pertaining to user interface presentations, and so forth. The filtering module can apply logic that is specifically tailored to a particular type of asset system when processing a request associated with that asset system. Likewise, the matching module can apply logic that is specifically tailored to a particular type of asset system when processing a request associated with that asset system.

Numerous exemplary benefits ensue from the approach described above. According to one advantage, there is no need for a system administrator to exhaustively define the manner in which different assets map to different permutations of set-top boxes that can deploy these assets. Rather, the administrator can simply add an asset to a database of assets by specifying only those characteristics which are particularly germane to the asset. In this sense, the asset-to-client associations are underspecified. During operation, the asset delivery system can automatically determine what assets match a set-top box's request for assets. This aspect of the system provides a more elegant approach to managing assets that is potentially easier to maintain (compared to an approach which attempts to establish an exhaustive one-to-one correlation between assets and set-top box permutations).

According to another advantage, the asset delivery functionality is highly extensible, meaning that it can easily be modified without requiring painstaking re-engineering of its main design principles. For instance, the asset delivery system can be modified to incorporate new assets, new asset systems, new parameter types and values, and so forth, all without disrupting the core design principles of the asset delivery system, and without requiring pervasive re-coding of the assets themselves. In other words, the system can gracefully evolve to incorporate new uses without requiring re-tooling of the system as a whole.

According to another advantage, the asset delivery system does not place unique demands on the set-top boxes themselves. Namely, the set-top boxes simply report all of their characteristics to the filtering module, and the filtering module decides which parameter types are germane to specific requests. This means that the asset delivery system can adopt a relatively agnostic approach to the set-top boxes that it interacts with. This has the twofold benefit of reducing the complexity of the asset delivery system, and allowing the asset delivery system to be used with a wide variety of set-top boxes without placing special demands on the set-top boxes.

Still further features and attendant benefits of the strategies will be set forth below.

The subject matter set forth in this Summary section refers to exemplary manifestations of the invention, and hence does not limit the scope of the invention set in the Claims section. More specifically, the Claims section may set forth aspects of the invention which are broader in scope than the concepts described in this Summary section.

### BRIEF DESCRIPTION OF THE DRAWINGS

FIG. 1 shows an exemplary system for providing assets to a collection of set-top boxes, using an asset delivery system that includes a filtering module and a matching module.

FIG. 2 shows exemplary components used by the system of FIG. 1, and also illustrates an exemplary manner of interaction among these components.

FIG. 3 shows further details of the asset delivery system of FIG. 1, particularly illustrating how different assets systems impact the operations of the filtering module and the matching module.

FIG. 4 shows an exemplary manner of operation of the system of FIG. 1.

FIG. 5 shows an exemplary computer environment for implementing aspects of the system of FIG. 1.

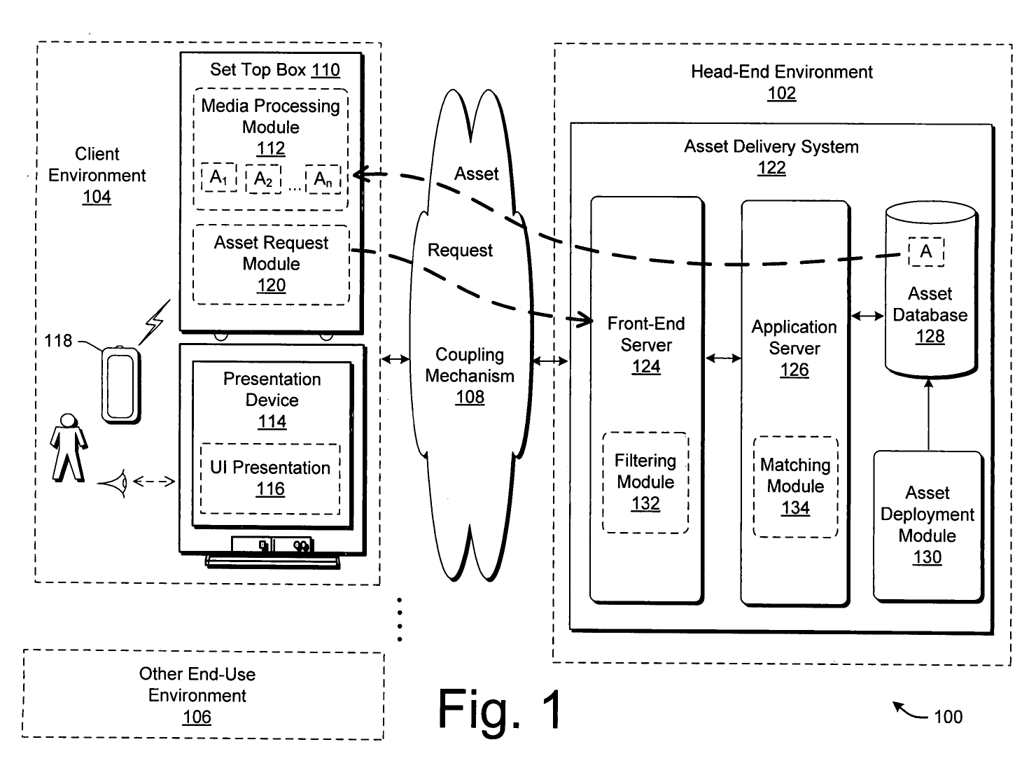

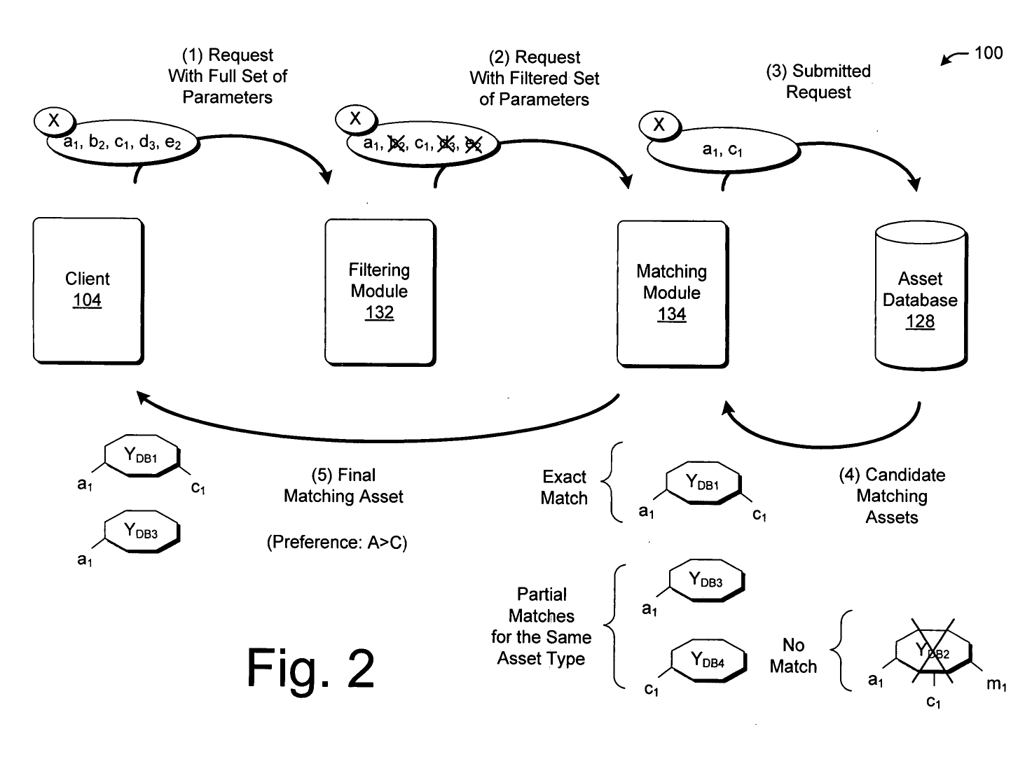

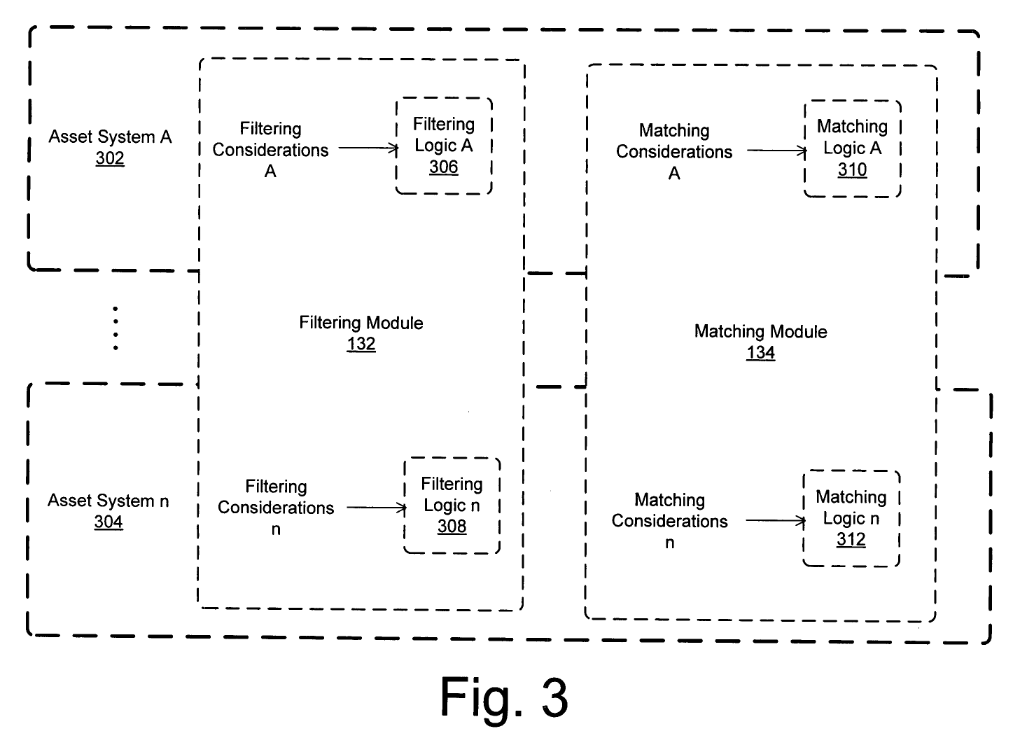

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

In brief, the strategies described herein provide functionality for delivering assets to a collection of set-top boxes. The strategies perform this task by intelligently matching set-top box characteristics with asset characteristics.

As a preliminary matter, certain terms used in this description are defined below:

The term “asset” describes any kind of resource that can be utilized by a client device for any purpose. The asset can have program logic content, or can have purely informational content, or can assume some other form or a combination of forms. Exemplary types of assets can include guide information, games, user interface presentation logic, advertisements, and so forth. Some assets are necessary to the proper functioning of the client device, while other assets can be optionally deployed by the set-top box.

The term “media information” pertains to any kind or combination of audio and/or visual data, such as music, still images, video, and so forth.

The term “client device” refers to any unit for interacting with another device in the role of a client. The exemplary client device featured in this disclosure is a set-top box. The set-top box can process and present media information that is delivered from head-end infrastructure.

The term “information item” refers to any information that describes a characteristic of a client device. A particular manifestation of an information item can comprise a “parameter name-value pair.” A parameter “name” identifies the subject matter (e.g., “type”) of parameter (such as language), and a parameter “value” identifies a specific species of the subject matter (such as English). A parameter name-value pair can be symbolically expressed as, for example, LNG=en, where LNG (for language) is the parameter type and “en” is the parameter value (for English), and the entire expression (LNG=en) constitutes one parameter name-value pair.

The term “set” should be liberally construed throughout this description as including a group of assets that can include one or more assets.

This disclosure includes the following sections. Section A presents an exemplary system for implementing the principles described herein. Section B describes an exemplary method of operation of the system of Section A. And Section C describes an exemplary computer environment for implementing aspects of the system of Section A.

A. Exemplary System

Generally, any of the functions described with reference to the figures can be implemented using software, firmware (e.g., fixed logic circuitry), manual processing, or a combination of these implementations. The term “logic, “module” or “functionality” as used herein generally represents software, firmware, or a combination of software and firmware. For instance, in the case of a software implementation, the term “logic,” “module,” or “functionality” represents program code (or declarative content) that performs specified tasks when executed on a processing device or devices (e.g., CPU or CPUs). The program code can be stored in one or more computer readable memory devices. More generally, the illustrated separation of logic, modules and functionality into distinct units may reflect an actual physical grouping and allocation of such software and/or hardware, or can correspond to a conceptual allocation of different tasks performed by a single software program and/or hardware unit. The illustrated logic, modules and functionality can be located at a single site (e.g., as implemented by a processing device), or can be distributed over plural locations.

A.1. Exemplary Client Environment

FIG. 1 shows an exemplary system 100 that includes head-end infrastructure 102 for providing media information to a plurality of client devices in a plurality of client environments (104, . . . 106) via coupling mechanism 108. In one exemplary implementation, the system 100 is implemented as a digital network, where media information is disseminated from the head-end infrastructure 102 to the client environments (104, . . . 106) in digital form. For example, the media information can be coded according to any standard (such as, but not limited to, MPEG-2), and packetized for dissemination to the client environments (104, . . . 106). In another implementation, the system 100 can provide media information in analog form for consumption by the client environments (104, . . . 106). In any event, the communication channel between the client environments (104, . . . 106) and the head-end environment 102 is two-way, meaning that the client environments (104, . . . 106) can send requests to the head-end environment 102 and receive data in response. The two-way channel can be implemented using different communication mechanisms for the uplink and downlink routes, or the channel can be implemented using the same communication mechanism for both uplink and downlink routes.

Exemplary client environment 104 includes a client device in the form of set-top box 110. Other types of client devices can be used, such as personal video recorders, any kind of computer device, and so forth. The set-top box 110 includes a media processing module 112 for receiving media information from one or more entities, for processing this media information, and for presenting the processed media information on a presentation device 114. The processing performed by the media processing module 112 can include tuning to one or more sources of media information (e.g., using one or more physical tuners or “virtual” multicast and/or unicast tuners), decoding the media information, combining the media information with supplemental information (such as supplemental graphical information), and so forth.

The media processing module 112 can also provide a number of applications not directly related to the processing and presentation of received media information. For example, the media processing module 112 can present electronic program guide (EPG) data that shows available programs. The media processing module 112 can also provide various computer games, user interface-related logic, and other applications. The user can interact with these applications via a user interface presentation 116 in conjunction with a remote control device 118 (or other kind of user input device). The user interface presentation 116 can overlay the entire screen of the presentation device 114, or a part of the screen. The client environments (104, . . . 106) can also optionally include, or can alternatively include, an audio interaction mechanism (e.g., a voice recognition mechanism).

More generally, the various resources of the set-top box 110 can be generalized as assets, A₁, A₂, A₃, . . . Aₙ. These assets can comprise programming resources, implemented as machine-readable code and/or declarative-type content (e.g., XML), which perform various functions when executed by one or more processing devices (e.g., CPUs). Alternatively, or in addition, one or more assets can comprise information that does not have an executable component, such as various images, and so forth. Still other kinds of assets are possible. More generally, some of the assets are essential to the proper functioning of the set-top box 110, while other asses are optional.

The strategies featured herein provide techniques for providing the assets used by the set-top box 110. By way of overview, an asset request module 120 allows the user to request one or more assets. The user can interact with the asset request module 120 via the remote control device 118 and the user interface presentation 116. In response to user's input (or in response to some other triggering event), the asset request module 120 formulates a request for one or more assets, and transmits the request to the head-end environment 102. The head-end environment 102 receives the request, processes it, and returns one or more assets that satisfy the request. Upon receipt, the asset request module 120 can act on the assets, such as by storing the assets, playing or presenting the assets, and so forth. For example, the user might request all games that can be played on the set-top box 110. In response, this causes the asset request module 120 to formulate a request for available games. The asset request module receives either a list of available games or perhaps the game application logic itself.

More specifically, the asset request module 120 can generate the request by identifying the nature of the asset being sought. The asset request module 120 can also specify information items that describe the features of the set-top box 110 itself. These information items are added to the request because the properties of the set-top box 110 have a bearing on what assets will satisfy the request. A particular manifestation of an information item can comprise a “parameter name-value pair.” A parameter “name” identifies the subject matter (e.g., “type”) of the parameter (such as language), and a parameter “value” identifies a specific species of the subject matter (such as English). The information items will be described in the remainder of the text as parameter name-value pairs, although it should be noted that other ways of representing the information items are possible.

Different types of set-top box parameter name-value pairs can be specified. The types can be symbolically associated with different parameter names. Exemplary set-top box parameter types include (but are not limited to):

A parameter type which pertains to the storage capability of the set-top box 110 (e.g., whether or not the set-top box 110 can store video information).

A parameter type which pertains to the processing speed of the set-top box 110.

A parameter type which pertains to the memory capacity of the set-top box 110.

A parameter type which pertains to the language used by the set-top box 110 to present information to the user (in graphical and/or audible form). In the United States, common languages include English and Spanish, while in Canada, common languages include English and French, and so forth.

A parameter type which pertains to the regional affiliation of the set-top box 110, which identifies the geographic location where the set-top box 110 is deployed. The regional affiliation can be expressed using a numeric code.

A parameter type which pertains to a level of service associated with the set-top box 110. The level of service typically describes the richness of service provided to the user of the set-top box. That is, the user typically pays different fees for different services, higher fees being associated with higher levels of service. For instance, a provider of services may allocate gold, silver and basic levels of services, where the gold service provides the richest set of functionality, and basic service provides the least rich set of functionality.

A parameter type which pertains to the demographic age range associated with the subscriber of the set-top box.

A parameter type which reflects whether the subscriber subscribes to voice and data service from a same service provider.

Still other kinds of parameter types are possible. It will be noted that some parameter types accept a continuous range of parameter values (such as processing speed or memory capacity), other parameter types accept a discrete group of possible parameter values (such as a discrete group of specific languages), while other parameter types accept a binary selection of parameter values (e.g., Y or N to indicate whether the set-top box possesses some characteristic).

In summary, one group of parameter types pertains to the physical capabilities of the set-top box. Another group of parameter types pertains to the circumstances in which the set-top is being used (such as the region in which the box is deployed, or the language in which the box presents information to the user). Another group of parameter types pertains to features which are more specifically dependent on the characteristics of the subscriber. Still other general groupings of parameter types are possible.

One way that the asset request module 120 can convey the parameter name-value paris is by packaging these name-value pairs into a header of the request sent to the head-end environment 102. For example, an information item pertaining to language can be expressed as LNG=EN, meaning that the language preference associated with the set-top box 110 is English. An information item pertaining to regional affiliation can be expressed as RGN=98743932, meaning that the geographic location in which the set-top box 110 is deployed is a region assigned the code 98743932. When combined together in the request, the parameter name-value pairs formulated by the asset request module 120 comprise an “original set of parameter name value pairs” according to the terminology used herein.

A.2. Overview of the Head-End Environment

Now turning to the head-end environment 102, this environment 102 serves various functions related to the delivery of media information to the client environments (104, . . . 106). In a typical media distribution arrangement, for instance, the head-end environment 102 comprises various functionality which delivers television programs and/or video-on-demand (VOD) resources to the client environments (102, . . . 104). The media information can be delivered via the coupling mechanism 108, which may comprise a digital network, cable routing infrastructure, satellite routing infrastructure, and so forth, or any combination thereof. The head-end environment 102 can include various other components associated with the delivery of media information, including a subscriber module, a billing module, and so forth. However, since these components are tangential to primary focus of this disclosure, further discussion of these features is omitted herein.

The component of the head-end environment 102 that processes the asset requests transmitted by set-top boxes is the asset delivery system 122. For a particular request, the purpose of the asset delivery system 122 is to interpret the request, determine one or more matching assets that match the request (to provide a set of candidate matching assets), select from the candidate assets one or more final assets, and disseminate the final assets to the requesting set-top box. The data processing aspects of the asset delivery system 122 can be implemented in hardware, software, or a combination of hardware and software. The database management aspects of the asset delivery system can be implemented by appropriate physical storage devices in conjunction with any kind of database management hardware and/or software.

In one exemplary implementation, the asset delivery system 122 includes a front-end server 124. One purpose of the front-end server 124 is to interact with the client environments (104, . . . 106), and to perform other preliminary tasks associated with the processing of asset requests (such as filtering the parameter name-value pairs included in the client requests). The front-end server 124 interacts with an application server 126. One purpose of the application server 126 is to provide any kind of application-related service, including the selection of assets which match the requests, and the dissemination of matching assets to the client environments (104, . . . 106). The asset delivery system 122 also includes an asset database 128. The asset database 128 comprises one or more stores for storing assets that can be delivered to the set-top boxes in response to requests for the assets. And finally, the asset delivery system 122 can include an asset maintenance module 130. The purpose of this module 130 is to add new assets to the asset database 128, to modify (and/or remove) existing assets in the database 128, and so forth.

Two principal components of the asset delivery system 122 are a filter module 132 and a matching module 132. These modules are shown as being implemented by the front-end server 124 and the application server 126, respectively, although other implementations are possible. For example, these two modules can be implemented as part of a single logic module that performs two distinct functions associated with filtering and matching, respectively.

The purpose of the filtering module 132 is to receive the original set of parameter name-value pairs from the set-top box 110 and to select a subset of the original parameter name-value pairs which are deemed relevant to the request. For example, assume that the set-top box 110 generates a request for program guide information. In one non-limiting implementation, two parameter types relevant to this request may be a parameter type which specifies the regional affiliation of the set-top box 110 and a parameter type which specifies the language used by the set-top box 110 to convey information to the user. Accordingly, assume that the set-top box 110 forwards an exemplary ten parameter name-value pairs pertaining to different aspects of the set-top box 110, including its physical capabilities, regional affiliation, preferred language, and so forth. From these ten parameter name-value pairs, the filtering module 132 can extract the parameter name-value pairs which are considered germane to the request, and exclude the remainder of the parameter name-value pairs. One way that the filtering module 132 can perform this role is by applying various rule logic. For example, if the request pertains to a certain domain of assets, then one rule might be to extract one or more parameter name-value pairs that are considered relevant to this domain. Such rules can be implemented using a mapping-type look-up table or some other kind of mechanism. For instance, one implementation uses an XML mapping table to perform the mapping. XML information in the XML mapping table specifies a list of parameter types pertinent to each domain, and this XML information can be changed at any time, even after deployment of the system. A later subsection of this disclosure describes how this operation can be implemented in the context of different so-called asset systems.

The output of the filtering module 132 is defined herein as a filtered set of parameter name-value pairs. The filtered set of parameter name-value pairs may comprise a subset which is smaller than the original set of parameter name-value pairs, but this need not be so. The filtering module 132 forwards the filtered set of parameter name-value pairs to the matching module 134.

The purpose of the matching module 134 is to identify the assets in the asset database 128 which match the filtered set of parameter name-values. This produces a candidate set of assets that match the filtered set of parameter name-value pairs. In one exemplary case, in a situation in which there are multiple matching candidates for a given asset type, the matching module 134 can be constrained such that it returns only one candidate. For example, assume that the user wishes to receive a list of all games. In operation, the asset request module 120 formulates and transmits a request for all games, in conjunction with the original set of parameter name-value pairs associated with the characteristics of the set-top box 110. Here, the asset domain is games and the asset type refers to different types of games. Assume that the matching module 134 determines that there are two candidates for the asset type poker, and two assets for the asset type solitaire. The matching module 134 will select one of the two poker games, as well as one of the two solitaire games. According to the terminology used herein, the resultant set of selected of assets comprises a final set of assets.

A.3. The Filtering and Matching Modules

FIG. 2 illustrates the manner operation of the filtering module 132 and the matching module 134. The components in this figure were introduced in the more comprehensive depiction of the system 100 in FIG. 1. By way of summary, the system 100 includes a client environment 104 which prepares and submits a request for one or more assets to the filtering module 132. The request includes an original set of parameter name-value pairs. The filtering module 132 filters the original set of parameter name-values to produce a filtered set of parameter name-value pairs. The matching module 134 determines which assets stored in the asset database 128 satisfy the filtered set of parameter name-value pairs, forming a candidate set of assets. If there are conflicts in the candidate set of assets (such as more than two assets pertaining to the same asset type), then the matching module 134 resolves the set of candidate assets into a final set of assets and forwards the final set of assets to the client environment 104.

FIG. 2 provides additional information regarding the operation of the filtering module 132 and the matching module 134 in the context of a specific example. Consider the case in which the client environment requests an asset X_{request} (such as all games), and that the original parameter name-value pairs that describe the client environment 104 include an entirely hypothetical set of name-value pairs: A=a₁, B=b₂, C=c₁, D=d₃ and E=e₂. For example, the parameter type A can refer to language, and the parameter value a₁ can correspond to English. Assume next that the filtering module 132 determines that only parameter types A and C are relevant to the request for asset X_{request}. The filtering module 132 therefore eliminates parameter name-value pairs B=b₂, D=d₃ and E=e₂ from the original set of parameter name-value pairs to produce a filtered set of parameter name-value pairs comprising parameter name-value pairs A=a₁ and C=c₁. As stated above, the filtering module 132 can perform this function by resorting to predefined rules which map certain requests to certain parameter types that are known to be relevant to the request, excluding the remainder of the parameter types.

The matching module 134 uses the filtered set of parameter name-value pairs (A=a₁ and C=c₁) to interrogate the asset database 128 to produce a set of candidate matching assets. The matching operation can be generalized as follows.

A so-called exact match occurs when there is a one-to-one correspondence between the parameter name-value pairs in the filtered set of parameter name-value pairs and the characteristics of an asset in the database 128. For example, assume that an administrator tagged an asset Y_{DB1} as having germane characteristics A=a₁ and C=c₁ when the administrator added this asset to the database 128. This asset Y_{DB1} constitutes an exact match for the request for asset X_{request}, which also specifies parameter name-value pairs A=a₁ and C=c₁. However, assume that another asset Y_{DB2} is associated with parameter name-value pairs A=a₁, C=c₁ and M=m₁. Since this database entry specifies an extra parameter name-value pair, M=m₁, that is not also specified in the request for asset X_{request}, then there is no match with respect to the database entry Y_{DB2}.

On the other hand, other database entries may have associated parameter name-value pairs which match only some of the parameter name-value pairs specified in the request. For example, a third database entry Y_{DB3} might associate only the parameter name-value pair A=a₁ with its asset, while a fourth database entry Y_{DB4} might associated only the parameter C=c₁ with its asset. These entries are so-called partial matches with respect to the parameter name-value pairs (A=a₁ and C=c₁) included in the filtered set of parameter name-value pairs associated with the request for asset X_{request}. These partial matches are added to the list of candidate assets because these assets at least do not contradict the conditions specified in the filtered set of parameter name-value pairs. FIG. 3 pictorially illustrates each of the above scenarios, including:

A first scenario in which a database asset (Y_{DB1}) exactly matches the filtered set of parameter name-value pairs (A=a₁ and C=c₁) and is accordingly added to the set of candidate assets.

A second scenario in which a database asset (Y_{DB2}) having parameter name-value pairs A=a₁, C=c₁ and M=m₁ is excluded from the set of candidate assets (because it specifies the parameter name-value pair M=m₁ which is not present in the filtered set of parameter name-value pairs).

A third scenario in which two database assets (Y_{DB3} and Y_{DB4}) having associated parameter name-value pairs A=a₁ and C=c₁, respectively, are added to the set of candidate assets as partial matches.

As described above, the matching module 134 can be constrained to return only one asset type, even though there might be plural candidate assets for this asset type. Again consider the case of a particular game, such as poker (which comprises an asset type encompassed by the general asset domain of games). The matching module 134 is configured to return only one kind of poker. To perform in this manner, the matching module 134 can include logic for selecting among the different candidate assets to yield a final matching asset.

The matching module 134 can select among competing candidate assets by applying preference analysis. The preference analysis determines which one of multiple candidate assets is preferable. There are different ways that this preference analysis can be implemented. Consider the case in which each candidate asset includes one parameter name-value pair which matches one of the filtered set of parameter name-value pairs. For example, in the scenario developed above, one candidate asset (Y_{DB3}) matches the request by virtue of the fact that it is associated with parameter name-value pair A=a₁, while another candidate asset (Y_{DB4}) matches the request by virtue of the fact that it is associated with parameter name-value pair C=c₁. In this case, the matching module 134 can rely on preference information which establishes a ranking between parameter types, such that an asset which matches by virtue of its agreement a highly-ranked parameter type is considered more desirable than an asset which matches by virtue of its agreement with a lower-ranked parameter type. In the example shown in FIG. 2, for instance, parameter type-A matches are considered more desirable than parameter type-C matches. Thus, the matching module 134 selects the candidate asset which matches by virtue of its agreement with parameter type A as a final matching asset to be conveyed to the client environment 104. The other asset in the final set of matching assets is the exact match candidate Y_{DB1}.

There are potentially more complex cases in which each candidate asset matches two or more parameter name-value pairs in the filtered set of parameter name-value pairs. In this case, a simple ranking of parameter types cannot by itself resolve the determination of what candidate asset is best. One way to address this situation is by assigning a numeric weight to each parameter type. The weight reflects the importance of a parameter type vis-à-vis other parameter types. Then, a score can be computed for each candidate asset by summing up the weights associated with its associated parameter types. Then, the matching module 134 can select the candidate asset having the best score. In this example, the scores are computed by summing the parameter weights to provide an approximation of the desirability of a candidate asset, but other implementations of the preference analysis are possible. Such other implementations can apply more complex selection strategies, such as strategies using neural network engines, expert system functionality, and so forth. The preference analysis can also include logic which adapts or learns based on its past performance, e.g., by reducing the weighting of asset selection options which have proved undesirable for any reason.

One of the benefits of the approach described above is that an administrator, using the asset maintenance module 130, can define only those parameter name-value types that are germane to an asset when the asset is added to the asset database 128. There is no need to establish an exhaustive one-to-one link between a new asset and every permutation of set-top box characteristics that can accommodate the new asset. Rather, the asset delivery system 122 automatically performs analysis to match a potentially sparse filtered set of parameter name-value pairs with a potentially spare set of asset characteristics. This benefit results in a substantial savings in maintaining the database 128. Further, the approach described above is highly flexible and extensible, allowing for the introduction of new set-top box designs, new assets, new parameter types and values, and so on. Still other advantages will be apparent those skilled in the art.

A.4. Asset Systems

FIG. 3 shows how the filtering and matching analysis described above can be performed in the context of plural so-called asset systems. An asset system describes logic functionality that is specifically tailored to processing requests pertaining to assets that belong to a certain asset domain (e.g., an asset genre). Exemplary types of asset systems include: a user interface asset system that handles asset-requests for logic associated with the user interface presentations of the set-top box 110; a guide-related asset system that handles asset-requests associated with electronic programming guides; a game-related asset system that handles asset-requests associated with games, and so forth. Many other types of asset systems are possible, including advertising-related asset systems that handle asset-requests associated with advertising assets. FIG. 3 depicts the concept of asset systems by in the context of generically-labeled asset systems (302, . . . 304).

The system 100 performs filtering and matching analysis in a manner that is tailored to each asset system, meaning that the filtering module 132 and matching module 134 can apply different considerations in processing requests pertain to different asset domains. FIG. 3 figuratively illustrates this concept by showing that the filtering module 132 and the matching module 134 overlap the different asset systems (302, . . . 304), meaning that these modules (132, 134) include logic which address these different asset systems (302, . . . 304). More specifically, the filtering module 132 provides special filtering logic 306 for asset system A 302, which may apply unique filtering considerations to system A 302. The filtering module 132 provides special filtering logic 308 for asset system n 304, which may apply unique filtering considerations to system n 304. The matching module 134 provides special matching logic 310 for asset system A 302, which may apply unique matching considerations to system A 302. The matching module 134 provides special matching logic 312 for asset system n 304, which may apply unique matching consideration to system n 304. To name but one specific illustration, different asset systems may apply different preference rankings to determine what partial matches should prevail over the others in case there are competing matches for a given asset type. For example, in the guide asset domain system, the region-affiliated parameter type could be ranked higher than the tier-related parameter type, and the tier-related parameter type could be ranked higher than the language-related parameter type, and so forth. But other asset systems may rank these parameter types in a different manner.

By virtue of the extensibility of the design of the asset delivery system 122, new asset systems can be added without contradicting the basic design approach used by the asset delivery system 122. The set-top box can possibly be configured to forward a modified set of parameter name-value pairs associated the new asset system, and the new asset system can be configured to process these new parameter name-value pairs. The basic algorithms used to filter the parameter name-value pairs and match the parameter name-value pairs remain unaltered. Further, there is no general need to re-code all of the existing assets in the database 128 to address the introduction of a new asset system.

B. Exemplary Processes

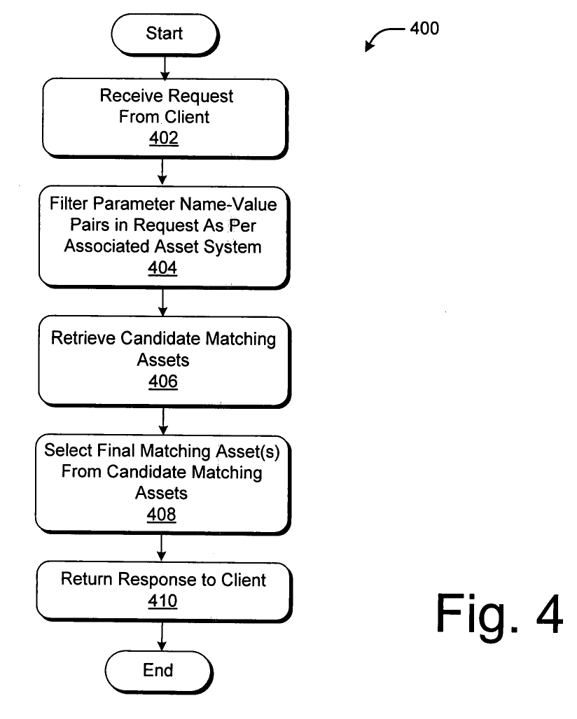

FIG. 4 shows a procedure 400 that explains an exemplary manner of operation of the system 100 shown in FIG. 1 (from the standpoint of the asset delivery system 122). To facilitate discussion, certain operations are described as constituting distinct steps performed in a certain order. Such implementations are exemplary and non-limiting. Certain steps described herein can be grouped together and performed in a single operation, and certain steps can be performed in an order that differs from the order employed in the examples set forth in this disclosure. As the operations described in this flowchart have already been explained in the context of the architecture of the system 100, this section will serve primarily as a review of those operations.

In step 402, the filtering module 132 receives a request for an asset from the client environment 104. The request includes an original set of parameter name-value pairs that describe the characteristics of the client environment 104.

In step 404, the filtering module 132 filters the original set of parameter name-value pairs to produce a filtered set of parameter name-value pairs. The filtered set of parameter name-value pairs comprises that subset of parameter name-value pairs that are considered germane to the request.

In step 406, the matching module 134 retrieves a set of candidate assets which match the filtered set of parameter name-value pairs. The set of candidate assets can contain one or more assets which exactly match the filtered set of parameter name-value pairs. The set of candidate assets can also contain one or more assets which only partially match the filtered set of parameter name-value pairs.

In step 408, the matching module selects a final set of matching assets from the candidate set of matching assets (if this operation is necessary because of competing candidate assets). This operation can involve applying preference analysis to select one asset in those cases where there are multiple candidate assets for the same asset type.

In step 410, the asset delivery system 122 provides the final matching asset (or assets) to the client environment 104.

C. Exemplary Computer Environment

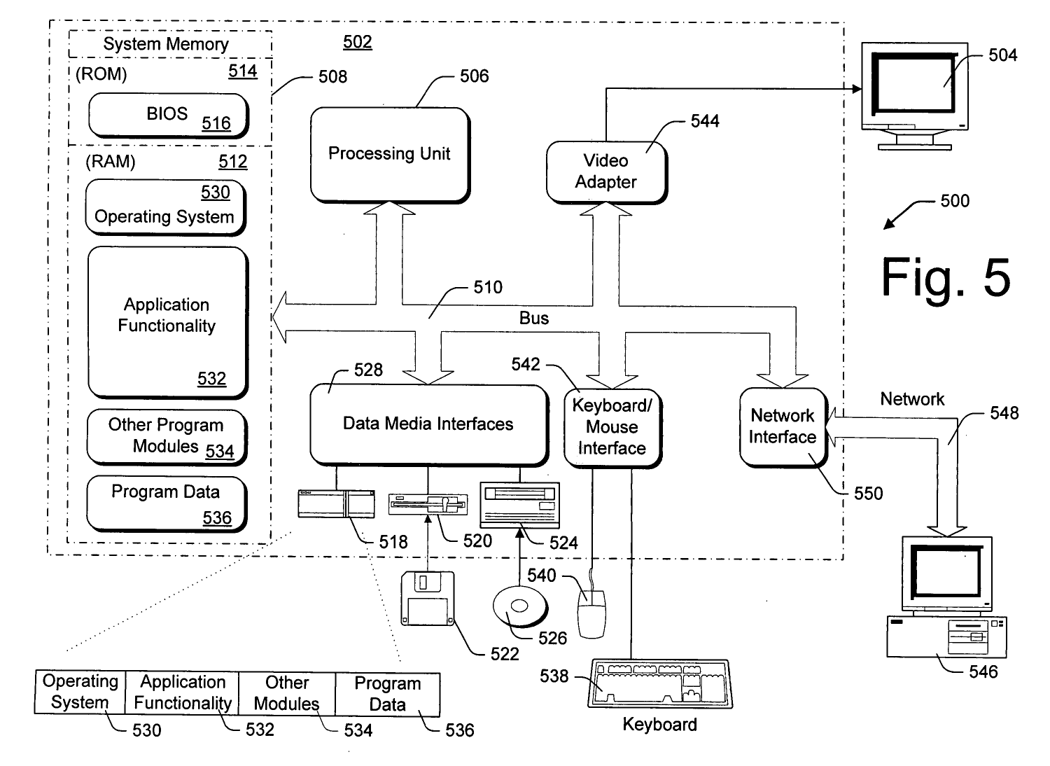

FIG. 5 provides information regarding a computer environment 500 that can be used to implement any of the processing functions described in the proceeding sections, such as one or more aspects of the asset delivery system 122.

The computing environment 500 includes a general purpose or sever type computer 502 and a display device 504. However, the computing environment 500 can include other kinds of computing equipment. For example, although not shown, the computer environment 500 can include hand-held or laptop devices, set top boxes, game consoles, mainframe computers, etc. Further, FIG. 5 shows elements of the computer environment 500 grouped together to facilitate discussion. However, the computing environment 500 can employ a distributed processing configuration. In a distributed computing environment, computing resources can be physically dispersed throughout the environment.

Exemplary computer 502 includes one or more processors or processing units 506, a system memory 508, and a bus 510. The bus 510 connects various system components together. For instance, the bus 510 connects the processor 506 to the system memory 508. The bus 510 can be implemented using any kind of bus structure or combination of bus structures, including a memory bus or memory controller, a peripheral bus, an accelerated graphics port, and a processor or local bus using any of a variety of bus architectures.

Computer 502 can also include a variety of computer readable media, including a variety of types of volatile and non-volatile media, each of which can be removable or non-removable. For example, system memory 508 includes computer readable media in the form of volatile memory, such as random access memory (RAM) 512, and non-volatile memory, such as read only memory (ROM) 514. ROM 514 includes an input/output system (BIOS) 516 that contains the basic routines that help to transfer information between elements within computer 502, such as during start-up. RAM 512 typically contains data and/or program modules in a form that can be quickly accessed by processing unit 506.

Other kinds of computer storage media include a hard disk drive 518 for reading from and writing to a non-removable, non-volatile magnetic media, a magnetic disk drive 520 for reading from and writing to a removable, non-volatile magnetic disk 522 (e.g., a “floppy disk”), and an optical disk drive 524 for reading from and/or writing to a removable, non-volatile optical disk 526 such as a CD-ROM, DVD-ROM, or other optical media. The hard disk drive 518, magnetic disk drive 520, and optical disk drive 524 are each connected to the system bus 510 by one or more data media interfaces 528. Alternatively, the hard disk drive 518, magnetic disk drive 520, and optical disk drive 524 can be connected to the system bus 510 by a SCSI interface (not shown), or other coupling mechanism. Although not shown, the computer 502 can include other types of computer readable media, such as magnetic cassettes or other magnetic storage devices, flash memory cards, CD-ROM, digital versatile disks (DVD) or other optical storage, electrically erasable programmable read-only memory (EEPROM), etc.

Generally, the above-identified computer readable media provide non-volatile storage of computer readable instructions, data structures, program modules, and other data for use by computer 502. For instance, the readable media can store the operating system 530, application-specific functionality 532 (including functionality for implementing aspects of the asset delivery system 122), other program modules 534, and program data 536.

The computer environment 500 can include a variety of input devices. For instance, the computer environment 500 includes the keyboard 538 and a pointing device 540 (e.g., a “mouse”) for entering commands and information into computer 502. The computer environment 500 can include other input devices (not illustrated), such as a microphone, joystick, game pad, satellite dish, serial port, scanner, card reading devices, digital or video camera, etc. Input/output interfaces 542 couple the input devices to the processing unit 506. More generally, input devices can be coupled to the computer 502 through any kind of interface and bus structures, such as a parallel port, serial port, game port, universal serial bus (USB) port, etc.

The computer environment 500 also includes the display device 504. A video adapter 544 couples the display device 504 to the bus 510. In addition to the display device 504, the computer environment 500 can include other output peripheral devices, such as speakers (not shown), a printer (not shown), etc.

Computer 502 operates in a networked environment using logical connections to one or more remote computers, such as a remote computing device 546. The remote computing device 546 can comprise any kind of computer equipment, including a general purpose personal computer, portable computer, a server, etc. Remote computing device 546 can include all of the features discussed above with respect to computer 502, or some subset thereof.

Any type of network 548 can be used to couple the computer 502 with remote computing device 546, such as the WAN 402 of FIG. 4, a LAN, etc. The computer 502 couples to the network 548 via network interface 550 (e.g., the interface 416 shown in FIG. 4), which can utilize broadband connectivity, modem connectivity, DSL connectivity, or other connection strategy. Although not illustrated, the computing environment 500 can provide wireless communication functionality for connecting computer 502 with remote computing device 546 (e.g., via modulated radio signals, modulated infrared signals, etc.).

In closing, a number of features were described herein by first identifying exemplary problems that these features can address. This manner of explication does not constitute an admission that others have appreciated and/or articulated the problems in the manner specified herein. Appreciation and articulation of the problems present in the relevant arts are to be understood as part of the present invention. More specifically, there is no admission herein that the features described in the Background section of this disclosure constitute prior art. Further, the description of a limited set of problems in the Background section does not limit the application of the invention to solving only those problems; it can be applied to problems and environments not expressly identified herein. Further, the subject matter set forth in the Summary section and the Abstract of this disclosure do not limit the subject matter set forth in the claims.

More generally, although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method for providing an asset to a client device, wherein the client device is used in conjunction with the delivery of media information, comprising:
receiving a request from the client device, the request specifying an original set of information items that describe respective characteristics of the client device;
filtering the original set of information items to provide a filtered set of information items, wherein the filtering comprises selecting one or more of the original set of information items that are deemed relevant to the request in view of the characteristics of the client device, to provide the filtered set of information items; and
determining at least one final asset which has characteristics which satisfy the filtered set of information items,
wherein the original set of information items includes one or more of:
an information item which describes a physical capability of the client device;
an information item which describes a language used by the client device to present information;
an information item which describes a region of operation of the client device; and
an information item which describes a level of service provided to the client device by a service provider.

2. The method of claim 1, wherein each information item is specified using a parameter name-value pair, the parameter name describing a type of parameter and the parameter value describing a species of the type.

3. The method of claim 1, wherein said at least one final asset has characteristics which satisfy all of the information items in the filtered set of information items.

4. The method of claim 1, wherein said at least one final asset does not have any stated characteristics that are not met by the information items in the filtered set of information items.

5. The method of claim 1, wherein the determining comprises:
determining a set of candidate assets which have characteristics which partially satisfy the filtered set of information items; and
determining said at least one final asset from the set of candidate assets based on preference analysis.

6. The method of claim 5, wherein the preference analysis comprises:
identifying a group of information item types associated with the set of candidate assets; and
selecting said at least one final asset as the asset which satisfies a filtered information item having an information type deemed most important in the group of information item types.

7. The method of claim 5, wherein the preference analysis comprises:
identifying a group of information item types associated with the set of candidate assets;
identifying a weight associated with each of the item types in the group of information item types;
evaluating a score of each candidate asset based on the weights assigned to this candidate's associated information item types; and
selecting said at least one final asset as the asset having a best score.

8. The method of claim 1, further comprising identifying an asset system associated with the request, and applying considerations pertinent to the identified asset system to the filtering of the original set of information items.

9. The method of claim 1, further comprising identifying an asset system associated with the request, and applying considerations pertinent to the identified asset system to the determining said at least one final asset.

10. One or more computer readable media comprising computer readable instructions for performing the method of claim 1.

11. A method for providing an asset to a client device, wherein the client device is used in conjunction with the delivery of media information, comprising:
receiving a request that specifies a set of information items;
determining a set of candidate assets which have characteristics which partially satisfy the set of information items; and
determining at least one final asset from the set of candidate assets based on preference analysis.

12. The method of claim 1, wherein each information item is specified using a parameter name-value pair, the parameter name describing a type of parameter and the parameter value describing a species of the type.

13. The method of claim 11, wherein the preference analysis comprises:
identifying a group of information item types associated with the set of candidate assets; and
selecting said at least one final asset as the asset which satisfies an information item having an information type deemed most important in the group of information item types.

14. The method of claim 11, wherein the preference analysis comprises:
identifying a group of information item types associated with the set of candidate assets;
identifying a weight associated with each of the information item type in the group of information item types;
evaluating a score of each candidate asset based on the weights assigned to this candidate's associated information item types; and
selecting said at least one final asset as the asset having a best score.

15. The method of claim 11, further comprising identifying an asset system associated with the request, and applying considerations pertinent to the identified asset system to the determining of said at least one final asset.

16. One or more computer readable media comprising computer readable instructions for performing the method of claim 11.

17. An apparatus for providing an asset to a client device, comprising:
logic configured to receive a request from the client device, the request specifying an original set of information items that describe respective characteristics of the client device;
logic configured to filter the original set of information items to provide a filtered set of information items, wherein the filtering comprises selecting one or more of the original set of information items that are deemed relevant to the request in view of the characteristics of the client device, to provide the filtered set of information items; and
logic configured to determine at least one final asset which has characteristics which satisfy the filtered set of information items,
wherein the original set of information items includes one or more of:
an information item which describes a physical capability of the client device;
an information item which describes a language used by the client device to present information;
an information item which describes a region of operation of the client device; and
an information item which describes a level of service provided to the client device by a service provider.

18. The apparatus of claim 17, wherein each information item is specified using a parameter name-value pair, the parameter name describing a type of parameter and the parameter value describing a species of the type.

19. The apparatus of claim 17, wherein the logic for determining comprises:
logic configured to determine a set of candidate assets which have characteristics which partially satisfy the filtered set of information items; and
logic configured to determine said at least one final asset from the set of candidate assets based on preference analysis, the preference analysis based on the assessed relative importance of different information item types.

20. One or more computer readable media comprising computer readable instructions for implementing the apparatus of claim 18.
